(19) United States
(12) Patent Application Publication
(10) Pub. No.: US 2012/0109508 A1
(43) Pub. Date: May 3, 2012

(54) METHOD AND SYSTEM FOR ROUTE NAVIGATION BASED ON ENERGY EFFICIENCY

(75) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/338,942

(22) Filed: Dec. 28, 2011

(51) Int. Cl. G01C 21/34

(52) U.S. Cl. 701/400

(57) ABSTRACT

Embodiments of the present invention provide a method and system for selecting a preferred route to a destination location. In accordance with an embodiment of the present invention, multiple routes to the destination location are determined. For each route of the multiple routes, an estimated amount of energy needed to travel to the destination location is calculated. A preferred route from the multiple routes is selected, the preferred route being the route with a lowest estimated amount of energy needed to travel to the destination location.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for route navigation based on energy efficiency.

### BACKGROUND OF THE INVENTION

The burning of fossil fuels to generate energy produces carbon dioxide, the primary contributor to environmental pollution. Pollution introduces contaminants into the natural environment causing harm to our ecosystem. Hence, it is desirable to reduce the demand for energy, which will reduce the burning of fossil fuels, such as coal, oil and natural gas. One way to diminish energy consumption is to decrease the fuel consumed by vehicles, as fuel combustion produces harmful chemicals that are released as exhaust.

The energy consumed by a vehicle can be reduced by using energy efficient routes. To determine whether a route is more energy efficient than another route, different parameters can be considered, such as the traffic congestion on the route. For example, the energy consumed by the vehicle can be reduced by traveling on a route with minimal traffic, as traffic causes the vehicle to constantly accelerate and brake. Currently, there is no easy way of determining an energy efficient route to a destination location or the different parameters that determine an energy efficient route.

What is needed is a method and system for route navigation based on energy efficiency.

### SUMMARY OF THE INVENTION

The present invention advantageously provides a method and system for route navigation based on energy efficiency. In accordance with one aspect, the invention provides a method in which multiple routes to a destination location are determined. For each route of the multiple routes, an estimated amount of energy needed to travel to the destination location is calculated. A preferred route from the multiple routes is selected, the preferred route being the route with a lowest estimated amount of energy needed to travel to the destination location.

In accordance with another aspect, the invention provides a system that includes a device having a processor. The processor determines multiple routes to a destination location and calculates, for each route of the multiple routes, an estimated amount of energy needed to travel to the destination location. The processor selects a preferred route from the multiple routes, the preferred route being the route with a lowest estimated amount of energy needed to travel to the destination location.

According to another aspect, the present invention provides a computer readable medium storing computer readable instructions that when executed by a processor, cause the processor to determine multiple routes to a destination location. The processor further calculates, for each route of the multiple routes, an estimated amount of energy needed to travel to the destination location. The processor then selects a preferred route from the multiple routes, the preferred route being the route with a lowest estimated amount of energy needed to travel to the destination location.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention

FIG. 2 is a block diagram of an exemplary device constructed in accordance with the principles of the present invention;

FIG. 3 is a block diagram of an exemplary database according to the principles of the present invention;

FIG. 4 is a block diagram of an exemplary server constructed in accordance with the principles of the present invention; and

FIG. 5 is a flow chart of an exemplary process for selecting an energy efficient route, in accordance with the principles of the present invention.

### DETAILED DESCRIPTION OF THE INVENTION

Embodiments of the present invention provide a method and system for selecting a preferred route to a destination location. In accordance with an embodiment of the present invention, multiple routes to the destination location are determined. An estimated amount of energy needed to travel to the destination location is calculated for each route of the multiple routes. A preferred route of the multiple routes is selected, the preferred route being the route with a lowest estimated amount of energy needed to travel to the destination location.

Before describing in detail exemplary embodiments that are in accordance with the present invention, it is noted that the embodiments reside primarily in combinations of apparatus components and processing steps related to implementing a method and system for selecting a preferred route to a destination location. Accordingly, the method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

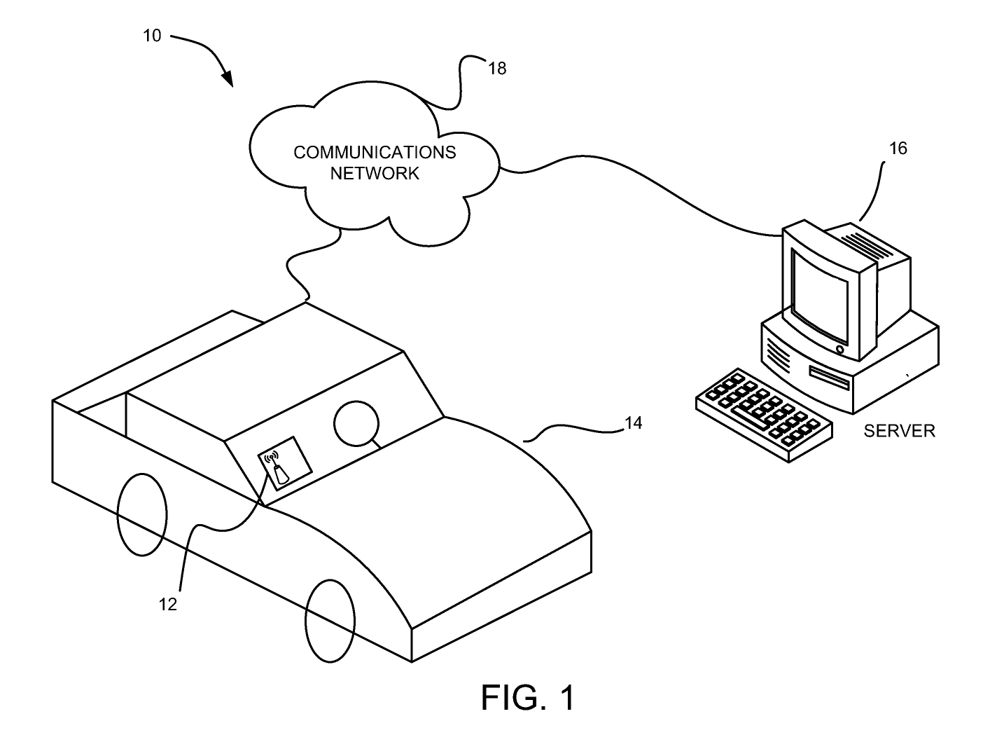

Referring now to the drawing figures in which reference designators refer to like elements, there is shown in FIG. 1 a schematic illustration of a system in accordance with the principles of the present invention, and generally designated as “10”. As shown in FIG. 1, a device 12 may be positionable on vehicle 14. Device 12 may be a vehicle navigation system, a portable navigation system, a vehicle computer, mobile device, personal computer, laptop computer, tablet computer, PDA, among other types of computing devices. A driver of vehicle 14 may wish to determine an energy efficient route to a destination location. Device 12 may receive input from the driver including the desired destination location. Device 12 determines different routes to the destination location. Device 12 calculates, for each route of the multiple routes, an estimated amount of energy needed to travel to the destination location. Device 12 may select a preferred route from the multiple routes, the preferred route having the lowest estimated amount of energy needed to travel to the destination location. In another embodiment, the user is presented with a list of the suggested routes, and given an opportunity to select a route.

Device 12 may be in communication with server 16 via communication network 18. Communication network 18 may include a cellular communication network and the Public Switched Telephone Network (PSTN), or other wide area network (WAN), such as the Internet, as well as local area networks (LANs), such as an Ethernet LAN. Communications network 18 may be a wireless network, such as Wi-Fi, satellite, infrared, Bluetooth, Near Field Communications, or other communications network. Device 12 and server 16 may be connected via communications network 18 to other computers, such as computers associated with a car manufacturer, a weather service or any other third party (not shown).

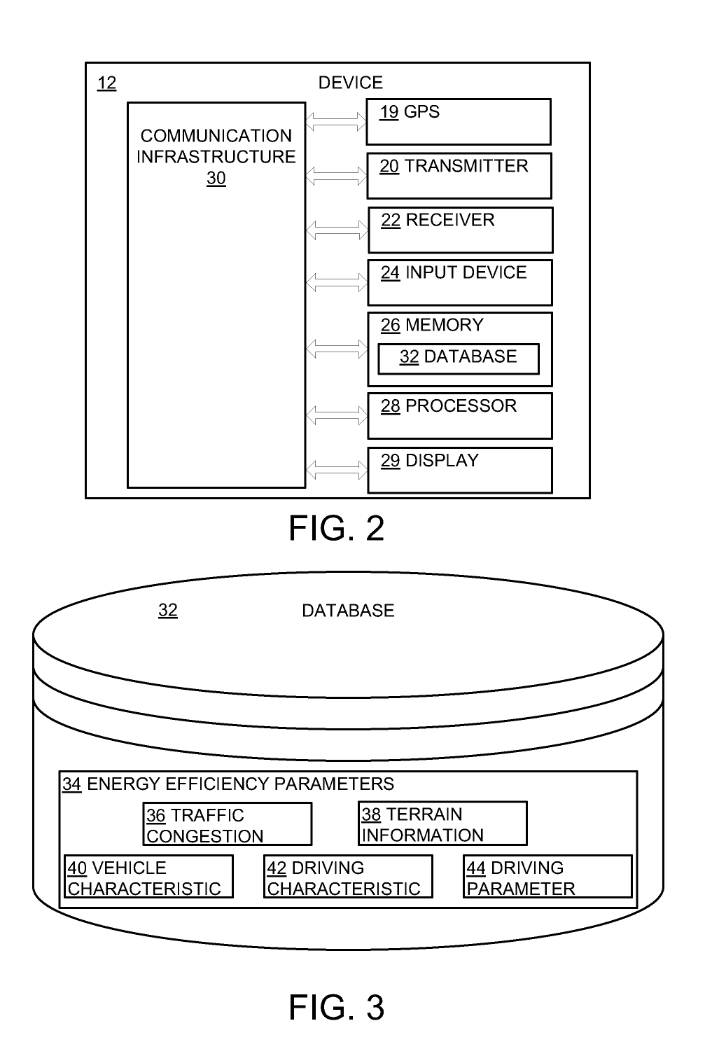

FIG. 2 is a block diagram of an exemplary device 12 constructed in accordance with the principles of the present invention. Device 12 may include global positioning system unit (“GPS”) 19, transmitter 20, receiver 22, input device 24, memory 26, processor 28 and display 29, all connected via communication infrastructure 30. Processor 28 may include a central processing unit (CPU) for performing device 12 functionality. Processor 28 is operatively coupled to a communication infrastructure 30, e.g., a communications bus, cross-bar interconnect, network, etc. Input device 24 may be a keyboard, a key pad or a touch pad. Device 12 may use transmitter 20 and receiver 22 for communicating with server 16 via communications network 18 wirelessly or by wire or optical fiber. Memory 26 may include random access memory (“RAM”) and read only memory (“ROM”). Memory 26 may store database 32. Computer programs (also called computer control logic) may be stored in memory 26. For example, computer programs are stored on memory 26 for execution by processor 28 via RAM, i.e. memory 26. Such computer programs, when executed, enable the method and system to perform the features of the present invention as discussed herein. In particular, the computer programs, when executed, enable processor 28 to perform the features of the corresponding method and system. Accordingly, such computer programs represent controllers of the corresponding device.

FIG. 3 is a block diagram of an exemplary database 32 constructed in accordance with the principles of the present invention. Database 32 may include energy efficiency parameters 34 for each route of the multiple routes that may be used to calculate the estimated amount of energy needed to travel to the destination location. A route may include multiple route segments. Database 32 may include energy efficiency parameters 34 for a route segment. Energy efficiency parameters 34 may include, but may not be limited to traffic congestion information 36, terrain information 38, at least one vehicle characteristic 40, at least one driving characteristic 42, and at least one driving parameter 44. Of note, although energy efficiency parameters 34 are described herein as being stored in a “database,” the invention is not limited to storage in a formal database management system, e.g., SQL. It is contemplated that any memory storage device can store energy efficiency parameters 34 in an organized and retrievable form, e.g. flat file.

Traffic congestion information 36 may include information associated with traffic conditions of a route, including but not limited to an average speed of vehicles travelling on the route, accidents along the route, a speed limit, closed roads, and construction along the route. For example, a route that includes a large number of traffic stops may cause vehicle 14 to consume more energy than a route with fewer traffic stops.

Terrain information 38 may include geospatial and topographic information associated with a route. Terrain information 38 may also include, but may not be limited to information associated with a route's roads, such as an elevation of the roads, road conditions, road temperature, road slope, and road contours. Additionally, terrain information 38 may include, for example, weather conditions, such as whether there is snow or ice on the roads, whether it is raining on the road, a wind speed, a direction of the wind, or whether there is a weather hazard, such as a tornado warning. For example, a route that includes roads that are covered with ice may cause vehicle 14 to consume more energy than a route that does not include icy roads. Terrain information 38 may also include information about the types of roads that a vehicle will encounter when travelling on the route, such as whether the route includes rural roads with shallow curves, suburban roads or urban roads that require frequent stops. Terrain information 38 may be obtained in real time from geostationary satellites.

Vehicle characteristic 40 may include, but may not be limited to a vehicle type, the make and model of vehicle 14, the shape of vehicle 14, a maintenance condition of vehicle 14, and whether vehicle 14 will be pulling a load, such as a trailer. For example, vehicle's 14 shape and weight may affect the aerodynamic drag of vehicle 14, causing an increase of the estimated amount of energy needed to travel to the destination. Vehicle type may include, but may not be limited to a pickup truck, a station wagon, a coupe, a sedan, a sport car, a van, a minivan, a sport utility vehicle, a motorcycle, a truck, a boat and an airplane. For example, a large and heavy truck may consume more energy than a light and compact car. Additionally, vehicle characteristic 40 may include information about the fuel consumption of vehicle 14, such as city and highway fuel consumption, i.e. an energy consumption rate of vehicle 14.

Driving characteristics 42 may include, but may not be limited to at least one of an age, gender, reaction time, visual capability, speeding habits and traffic citations/accidents associated with a driver. Additionally, driving characteristics 42 may also include whether the driver is a risky driver that frequently change lanes, passes other vehicles, tailgates, honks and out-maneuvers other vehicles. For example, aggressive driving practices may cause vehicle 14 to consume more energy, given the constant braking and accelerating associated with aggressive driving. Device 12 may monitor a driver's driving style and store at least one driving characteristic 42 associated with the way a driver drives in database 32. Driving characteristics 42 may be configured and customized by a driver of vehicle 14. Driving characteristics 42 may be stored in a driving profile for each driver of vehicle 14.

Driving parameters 44 may include a driver's preference(s) or requirement(s) for the route considered in addition to the energy consumption. Driver parameters 44 may include input received from a driver. Driving parameter 44 may include the purpose of the trip, such as business or pleasure. For example, a driver may wish to take the route that takes the shortest amount of time to the destination location if on a hurry, or may wish to take a scenery route if the driver is on vacation. Driving parameters 44 may include, but not be limited to a desired travel time, a scenery, travel purpose, desired stops along the way, rest stop availability, etc. The driver may further specify a type of scenery road desired for the trip, such as a scenery road that includes lakes, mountains, valleys, orchards, farms, small towns, historic places, or national parks. For example, if the trip is part of a family vacation, the selected preferred route may be a route that includes theme parks and family entertainment centers.

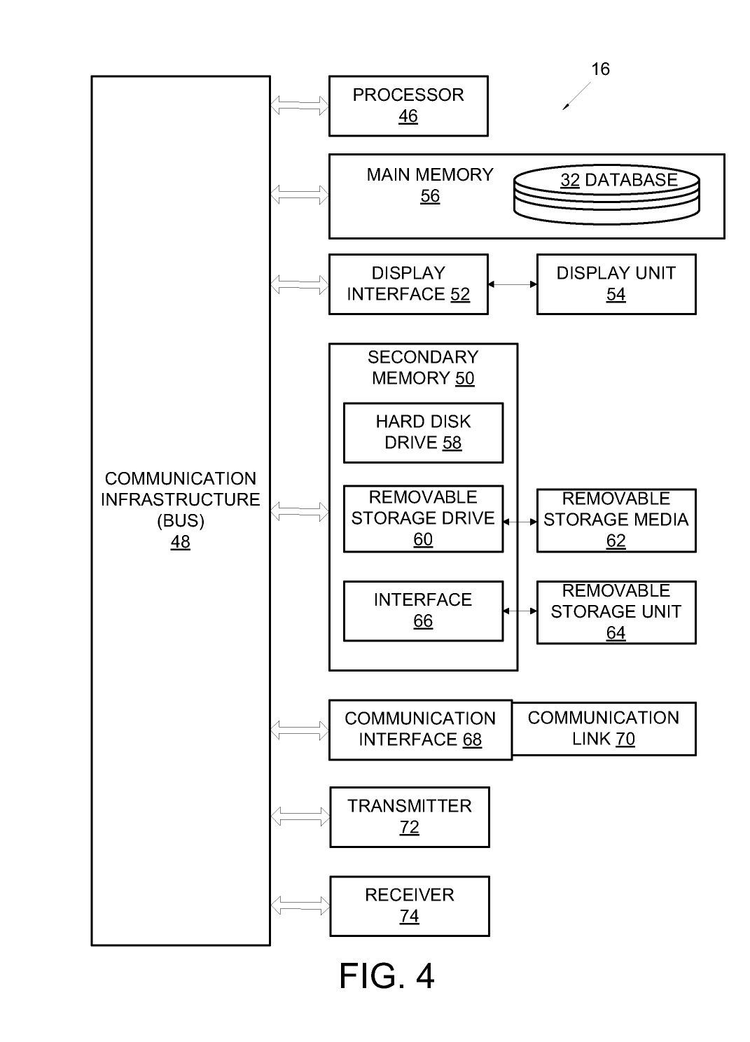

FIG. 4 is a block diagram of an exemplary server 16 constructed in accordance with the principles of the present invention. Server 16 includes one or more processors, such as processor 46 programmed to perform the functions described herein. Processor 46 is operatively coupled to a communication infrastructure 48, e.g., a communications bus, cross-bar interconnect, network, etc. Processor 46 may execute computer programs stored on disk storage for execution via secondary memory 50. Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of server 16 may be designed to occur remotely by web browser. In such case, the inclusion of a display interface and display unit may not be required.

Server 16 may optionally include or share a display interface 52 that forwards graphics, text, and other data from the communication infrastructure 48 (or from a frame buffer not shown) for display on the display unit 54. Display 54 may be a cathode ray tube (CRT) display, liquid crystal display (LCD), light-emitting diode (LED) display, and touch screen display, among other types of displays. The computer system also includes a main memory 56, such as random access memory (“RAM”) and read only memory (“ROM”), and may also include secondary memory 50. Main memory 56 may store database 32.

Secondary memory 50 may include, for example, a hard disk drive 58 and/or a removable storage drive 60, representing a removable hard disk drive, magnetic tape drive, an optical disk drive, a memory stick, etc. The removable storage drive 60 reads from and/or writes to a removable storage media 62 in a manner well known to those having ordinary skill in the art. Removable storage media 62, represents, for example, a floppy disk, external hard disk, magnetic tape, optical disk, etc. which is read by and written to by removable storage drive 60. As will be appreciated, the removable storage media 62 includes a computer usable storage medium having stored therein computer software and/or data.

In alternative embodiments, secondary memory 50 may include other similar devices for allowing computer programs or other instructions to be loaded into the computer system and for storing data. Such devices may include, for example, a removable storage unit 64 and an interface 66. Examples of such may include a program cartridge and cartridge interface (such as that found in video game devices), flash memory, a removable memory chip (such as an EPROM, EEPROM or PROM) and associated socket, and other removable storage units 64 and interfaces 66 which allow software and data to be transferred from the removable storage unit 64 to other devices.

Server 16 may also include a communications interface 68. Communications interface 68 allows software and data to be transferred to external devices. Examples of communications interface 68 may include a modem, a network interface (such as an Ethernet card), a communications port, a PCMCIA slot and card, wireless transceiver/antenna, etc. Software and data transferred via communications interface/module 68 may be, for example, electronic, electromagnetic, optical, or other signals capable of being received by communications interface 68. These signals are provided to communications interface 68 via the communications link (i.e., channel) 70. Channel 70 carries signals and may be implemented using wire or cable, fiber optics, a phone line, a cellular phone link, an RF link, and/or other communications channels.

It is understood that server 16 may have more than one set of communication interface 68 and communication link 70. For example, server 16 may have a communication interface 68/communication link 70 pair to establish a communication zone for wireless communication, a second communication interface 68/communication link 70 pair for low speed, e.g., WLAN, wireless communication, another communication interface 68/communication link 70 pair for communication with low speed wireless networks, and still another communication interface 68/communication link 70 pair for other communication.

Computer programs (also called computer control logic) are stored in main memory 56 and/or secondary memory 50. For example, computer programs are stored on disk storage, i.e. secondary memory 50, for execution by processor 46 via RAM, i.e. main memory 56. Computer programs may also be received via communications interface 68. Such computer programs, when executed, enable the method and system to perform the features of the present invention as discussed herein. In particular, the computer programs, when executed, enable processor 46 to perform the features of the corresponding method and system. Accordingly, such computer programs represent controllers of the corresponding device. Server 16 also includes transmitter 72 and receiver 74. Processor 46 communicates with transmitter 72 and receiver 74 via communication infrastructure 48. Server 16 may communicate with device 12 via communications network 18.

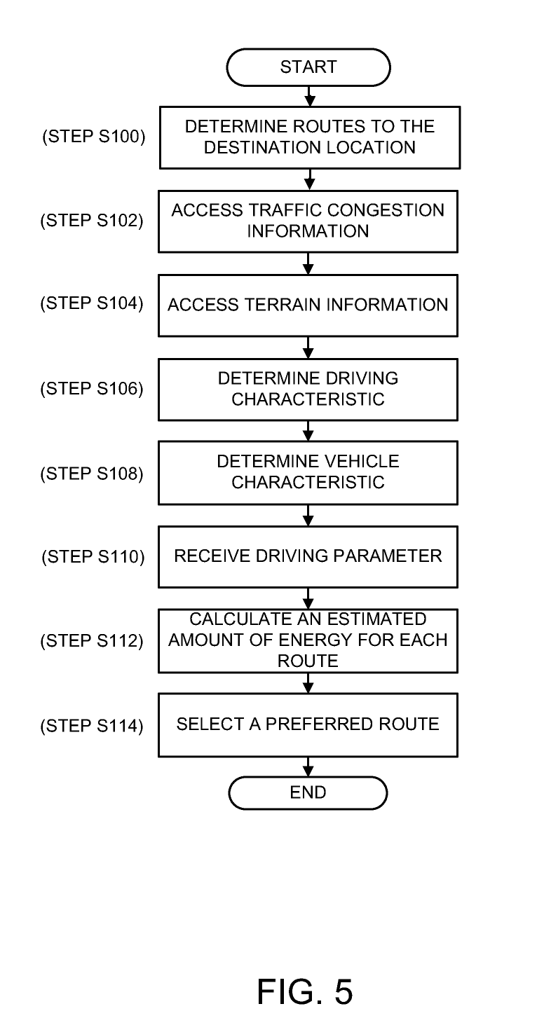

FIG. 5 is a flow chart of an exemplary process for selecting a preferred energy efficient route, in accordance with the principles of the present invention. One or more routes to a destination location are determined (Step S100). Methods for generally determining routes from a source location to a destination location, for example using a GPS, are known and are beyond the scope of this invention. Traffic congestion information 36 and terrain information 38 for each route of the multiple routes is accessed (Steps S102 and S104). At least one driving characteristic 42 and at least one vehicle characteristic 40 may be determined (Step S106 and S108). At least one driving parameter 44 may be received from the driver (Step S110). An estimated amount of energy needed to travel to the destination location for each route of the multiple routes may be calculated (Step 112). A preferred route from the multiple routes may be selected (Step S114). The preferred route may be the route with a lowest estimated amount of energy needed to travel to the destination location. It is also contemplated that the preferred route can be based on additional criteria such as shortest time with highest energy efficiency, highest energy efficiency with least elapsed distance, or other multiple factors. The determination as to which method to use to determine the preferred route can be user selectable.

In an alternate embodiment, the user may be presented with a list of the multiple routes and offered the opportunity to select the route preferred by the user. The multiple routes can be presented visually and/or audibly, with the user's selection being captured by selecting an area on the display 29 or via input device 24, or captured through voice recognition. The routes can be ordered from most to least efficient, or vice versa. It is contemplated that the user can override this feature, thereby allowing the device 12 to select the preferred route. Although Steps S102 through S110 are shown in FIG. 5 in a particular order, the invention is not limited to such. Only one or more of Steps S102-S110 need to be considered and the steps do not need to be executed in the order shown.

In an exemplary embodiment, input device 24 may be used to input a desired destination location. The destination location may include, but may not be limited to an address, a partial address, such as a zip code, a name of a city or a name of a well known business or landmark. A driver may store different destination locations in device 12 or server 16, and give each destination location an identifier, such as “Home” or “Work.” Processor 28 may determine multiple routes to the destination location (Step S100). Processor 28 may query database 32 to retrieve energy efficiency parameters 34 for use in calculating, for each route of the multiple routes, an estimated amount of energy needed to travel to the destination. Processor 28 may calculate, for each route of the multiple routes, an estimated amount of energy needed to travel to the destination location based on at least one of a route's traffic congestion information 36, terrain information 38, vehicle characteristic 40, driving characteristic 42, and driving parameter 44 (Step S112). Processor 28 may select a preferred route from the multiple routes, the preferred route being the route with a lowest estimated amount of energy needed to travel to the destination location (Step S114).

In another exemplary embodiment, server 16 may receive from device 12 a destination location. Input device 24 may be used to enter a desired destination location. Transmitter 20 may transmit the destination location to server 16 via communications network 18. Receiver 74 of server 16 may receive the destination location. Processor 46 may determine multiple routes to the destination location (Step S100). Processor 46 may query database 32 in main memory 56 to retrieve energy efficiency parameters 34 for use in calculating, for each route of the multiple routes, an estimated amount of energy needed to travel to the destination location. Processor 46 may calculate an estimated amount of energy for each route based on at least one of a route's traffic congestion information 36, terrain information 38, vehicle characteristic 40, driving characteristic 42, and driving parameter 44 (Step S112). Processor 46 may select a preferred route from the multiple routes, the preferred route being the route with a lowest estimated amount of energy needed to travel to the destination location (Step S114). Transmitter 72 may send the preferred route to receiver 22 via communications network 18.

In another exemplary embodiment, vehicle 14 may be a hybrid vehicle that includes two or more power sources. Power sources may include but may not be limited to a rechargeable energy system, natural gas, solar, gasoline, diesel, hydrogen, and electricity. For example, vehicle 14 may include both an internal combustion engine and an electric motor. The estimated amount of energy consumed by vehicle 14 to travel on a route to a destination location may depend on the power source used by vehicle 14. For example, vehicle 14 may consume more energy when using an internal combustion engine as a power source than when using a hydrogen gas power source. Additionally, the amount of energy consumed by vehicle 14 may depend on energy efficient features of vehicle 14. For example, vehicle 14 may include regenerative breaking that converts the vehicle's kinetic energy into electric energy used to charge a battery.

Device 12 or server 16 may determine whether vehicle 14 includes multiple power sources. Device 12 or server 16 may calculate, for each of the power sources, the estimated amount of energy vehicle 14 needs to travel to the destination location. For example, device 12 or server 16 may determine an estimated amount of fuel and an estimated amount of electricity needed by vehicle 14 to travel to the destination location. Calculating the estimated amount of energy needed to travel to the destination may be based at least in part on the estimated amount of fuel and the estimated amount of electricity.

Additionally, device 12 or server 16 may query database 32 to retrieve energy efficiency parameters 34 for use in calculating, for each route of the multiple routes, an estimated amount of energy needed to travel to the destination location. The estimated amount of energy for each route may be based not only on the estimated amount of fuel and electricity needed by hybrid vehicle 14, but also on at least one of a route's traffic congestion information 36, terrain information 38, vehicle characteristic 40, driving characteristic 42, and driving parameter 44. A preferred route from the multiple routes may be selected, the preferred route being the route with a lowest estimated amount of energy needed to travel to the destination location.

The present invention can be realized in hardware or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program, software or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for selecting a preferred route to a destination location, the method comprising:
determining a plurality of routes to the destination location;
calculating, for each route of the plurality of routes, an estimated amount of energy needed to travel to the destination location; and
selecting the preferred route from the plurality of routes, the preferred route being the route with a lowest estimated amount of energy needed to travel to the destination location.

2. The method of claim 1, wherein calculating for each route of the plurality of routes an estimated amount of energy further comprises:
accessing traffic congestion information; and
determining the estimated amount of energy based at least in part on the traffic congestion information.

3. The method of claim 1, wherein calculating for each route of the plurality of routes an estimated amount of energy further comprises:
accessing terrain information; and
determining the estimated amount of energy based at least in part on the terrain information.

4. The method of claim 1, wherein calculating for each route of the plurality of routes an estimated amount of energy further comprises:
determining at least one driving characteristic of a driver of a vehicle travelling to the destination location; and
determining the estimated amount of energy based at least in part on the at least one driving characteristic.

5. The method of claim 1, wherein calculating for each route of the plurality of routes an estimated amount of energy further comprises:
determining at least one vehicle characteristic, the vehicle characteristic including at least one of a vehicle type and an energy consumption rate of the corresponding vehicle; and
determining the estimated amount of energy based at least in part on the at least one vehicle characteristic.

6. The method of claim 1, wherein calculating for each route of the plurality of routes an estimated amount of energy further comprises:
receiving at least one driving parameter, the driving parameter including at least one of a desired travel time and travel purpose; and
determining the estimated amount of energy based at least in part on the at least one driving parameter.

7. The method of claim 1, wherein calculating for each route of the plurality of routes an estimated amount of energy further comprises:
determining an estimated amount of fuel needed by a hybrid vehicle to travel to the destination location;
determining an estimated amount of electricity needed by the hybrid vehicle to travel to the destination location, the estimated amount of energy based at least in part on the estimated amount of fuel and the estimated amount of electricity needed by the hybrid vehicle to travel to the destination location.

8. The method of claim 1, wherein selecting the preferred route from the plurality of routes includes:
presenting at least a portion of the plurality of routes for selection by a user; and
receiving a selected one of the provided at least a portion of the plurality of routes.

9. A system for selecting a preferred route to a destination location, the system comprising:
a device, the device including a processor, the processor:
determining a plurality of routes to the destination location;
calculating, for each route of the plurality of routes, an estimated amount of energy needed to travel to the destination location; and
selecting the preferred route from the plurality of routes, the preferred route being the route with a lowest estimated amount of energy needed to travel to the destination location.

10. The system of claim 9, the processor further:
accessing traffic congestion information; and
determining the estimated amount of energy based at least in part on the traffic congestion information.

11. The system of claim 9, the processor further:
accessing terrain information; and
determining the estimated amount of energy based at least in part on the terrain information.

12. The system of claim 9, the processor further:
determining at least one driving characteristic of a driver of a vehicle travelling to the destination location; and
determining the estimated amount of energy based at least in part on the at least one driving characteristic.

13. The system of claim 9, the processor further:
determining at least one vehicle characteristic, the vehicle characteristic including at least one of a vehicle type and an energy consumption rate of the corresponding vehicle; and
determining the estimated amount of energy based at least in part on the at least one vehicle characteristic.

14. The system of claim 9, the processor further:
receiving at least one driving parameter, the driving parameter including at least one of a desired travel time and travel purpose; and
determining the estimated amount of energy based at least in part on the at least one driving parameter.

15. The system of claim 9, the system further comprising a server, the server transmitting route information to the device; and
the processor determining the estimated amount of energy based at least in part on the route information.

16. A computer readable medium storing computer readable instructions that when executed by a processor, cause the processor to perform a method comprising:
determining a plurality of routes to a destination location;
calculating, for each route of the plurality of routes, an estimated amount of energy needed to travel to the destination location; and
selecting a preferred route from the plurality of routes, the preferred route being the route with a lowest estimated amount of energy needed to travel to the destination location.

17. The computer readable medium of claim 16, wherein calculating for each route of the plurality of routes an estimated amount of energy further comprises:
accessing traffic congestion information; and
determining the estimated amount of energy based at least in part on the traffic congestion information.

18. The computer readable medium of claim 16, wherein calculating for each route of the plurality of routes an estimated amount of energy further comprises:
accessing terrain information; and
determining the estimated amount of energy based at least in part on the terrain information.

19. The computer readable medium of claim 16, wherein calculating for each route of the plurality of routes an estimated amount of energy further comprises:
determining at least one driving characteristic of a driver of a vehicle travelling to the destination location; and
determining the estimated amount of energy based at least in part on the at least one driving characteristic.

20. The computer readable medium of claim 16, wherein calculating for each route of the plurality of routes an estimated amount of energy further comprises:
determining at least one vehicle characteristic, the vehicle characteristic including at least one of a vehicle type and an energy consumption rate of the corresponding vehicle; and
determining the estimated amount of energy based at least in part on the at least one vehicle characteristic.
